(19) United States
(12) Patent Application Publication
(10) Pub. No.: US 2015/0371070 A1
(43) Pub. Date: Dec. 24, 2015

(54) EFFICIENT OPTICAL ILLUMINATION SYSTEM AND METHOD FOR AN IMAGING READER

(71) Applicant: SYMBOL TECHNOLOGIES, INC., Schauburg, IL (US)

(72) Inventors: David T. Shi, Stony Brook, NY (US); Rong Liu, Great Neck, NY (US)

(21) Appl. No.: 14/311,389

(22) Filed: Jun. 23, 2014

(51) Int. Cl. G06K 7/10

(52) U.S. Cl. CPC G06K 7/10732; G06K 7/10831

(57) ABSTRACT

A target to be read by image capture is illuminated with an illumination light pattern by an illuminating light assembly having an enhanced optical coupling efficiency. The assembly includes a hybrid lens component having a first lens portion centered on an optical axis, and a second total internal reflection (TIR) lens portion surrounding the first lens portion about the optical axis. Both lens portions intercept, bend and collimate illumination light emitted from a light emitting diode. The collimated light is incident on a lenslet component having an array of lenslets generally arranged in a plane that is generally perpendicular to the optical axis.

### BACKGROUND OF THE INVENTION

The present disclosure relates generally to an optical illumination system for, and a method of, enhancing the optical coupling efficiency or throughput of illumination light used to illuminate a target during operation of an imaging module of an imaging reader.

Solid-state imaging systems or imaging readers have been used, in both handheld and/or hands-free modes of operation, to electro-optically read targets, such as one- and two-dimensional bar code symbol targets, and/or non-symbol targets, such as documents. A handheld imaging reader includes a housing having a handle held by an operator, and an imaging module, also known as a scan engine, supported by the housing and aimed by the operator at a target during reading. The imaging module includes a solid-state imager or imaging sensor with an array of photocells or light sensors, which correspond to image elements or pixels in a field of view of the imager, and an imaging lens assembly for capturing return light scattered and/or reflected from the target being imaged, and for projecting the return light onto the array to initiate capture of an image of the target. Such an imager may include a one- or two-dimensional charge coupled device (CCD) or a complementary metal oxide semiconductor (CMOS) device and associated circuits for producing and processing electronic signals corresponding to a one- or two-dimensional array of pixel data over the field of view.

In order to increase the amount of the return light captured by the array, especially in dimly lit environments and/or at far range reading, the imaging module generally also includes an illuminating light assembly for illuminating the target with illumination light in an illumination pattern for reflection and scattering therefrom. There are many types of illumination patterns. For example, the illumination pattern may be one-dimensional, i.e., linear, also termed an illuminating line that extends lengthwise along the target, or may be two-dimensional, e.g., a generally rectangular illumination area, that extends lengthwise and heightwise over the target. The illumination pattern is typically generated by using a single light source, e.g., a light emitting diode (LED) sized in the millimeter range and a single cylindrical lens.

Although generally satisfactory for its intended purpose, the use of the single LED and the single cylindrical lens has been problematic, because the two-dimensional illumination pattern typically does not have sharp edges, is dominated by optical aberrations, and is non-uniform in intensity since the light intensity is brightest along an optical axis on which the LED is centered, and then falls off away from the axis, especially at opposite end regions of the illumination pattern. Also, the optical coupling efficiency between the LED and the cylindrical lens has been poor. Adding an aperture stop between the LED and the cylindrical lens will improve the sharpness (i.e., shorten the height) of the illumination pattern, but at the cost of a poorer optical coupling efficiency and a dimmer illumination pattern that, of course, degrades reading performance.

For a brighter illumination pattern, a plurality of LEDs and a corresponding plurality of cylindrical lenses could be employed. However, this further increases cost, introduces more optical aberrations, and further reduces the optical coupling efficiency. Also, the illumination light emitted by the pair of LEDs overlap at a central region of the illumination pattern, thereby creating a bright, “hot” spot and abrupt light intensity transitions in the illumination pattern, all of which can cause reading performance to deteriorate.

Accordingly, there is a need for enhancing the efficiency or throughput of illumination light used to illuminate a target during operation of an imaging module of an imaging reader.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a side elevational view of a portable imaging reader operative for efficiently generating an illumination pattern of light on and along a target to be read by image capture in accordance with this invention.

FIG. 2 is a schematic diagram of various components of the reader of FIG. 1.

FIG. 3 is an enlarged side sectional view depicting operation of components of the illuminating light assembly of FIG. 2.

FIG. 4 is an view of a lenslet array component of the illuminating light assembly of FIG. 3.

FIG. 5 is a sectional view of the lenslet array component of FIG. 4.

FIG. 6 is a plan view of an illumination pattern produced by the illuminating light assembly of FIG. 2.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of the present disclosure relates to an optical illumination system for illuminating a target to be read by image capture. The illumination system includes an illumination light source component, preferably a light emitting diode (LED), for emitting illumination light, and a hybrid lens component including a first lens portion centered on an optical axis, and a second total internal reflection (TIR) lens portion surrounding the first lens portion about the optical axis. Both lens portions are operative for intercepting, bending and collimating the emitted illumination light with an enhanced optical coupling efficiency to generate an illumination light pattern on the target. Advantageously, the first lens portion is a positive lens having a convex surface on which the emitted illumination light is incident, and the TIR lens portion is a parabolic reflector element.

In a preferred embodiment, a lenslet component, which is configured as an array of lenslets, is generally arranged in a plane that is generally perpendicular to the optical axis. The hybrid lens component preferably has a cavity in which the lenslet component is mounted. The lenslets have individual input aspherical surfaces on which the collimated illumination light is incident, and individual output aspherical surfaces for forming the illumination light pattern. The lenslets are arranged in mutually orthogonal rows and columns, and the lenslets at the ends of the rows and columns have different optical properties than the remaining lenslets to form the illumination light pattern with regions of different light intensity.

Another aspect of the present disclosure relates to an imaging module for illuminating and imaging an illuminated target to be read by image capture. The module comprises an illuminating light assembly that includes an illumination light source for emitting illumination light, and a hybrid lens component including a first lens portion centered on an optical axis, and a second total internal reflection (TIR) lens portion surrounding the first lens portion about the optical axis. Both lens portions are operative for intercepting, bending and collimating the emitted illumination light with an enhanced optical coupling efficiency to generate an illumination light pattern on the target. The module also comprises an imaging assembly that includes a solid-state imager having an imaging array of image sensors and an imaging lens assembly for capturing return light over a field of view from the illuminated target, and for projecting the captured return light onto the imaging array.

Still another aspect of the present disclosure relates to a method of illuminating and imaging an illuminated target to be read by image capture. The method is performed by emitting illumination light, and by intercepting, bending and collimating the emitted illumination light with an enhanced optical coupling efficiency to generate an illumination light pattern on the target by configuring a hybrid lens component with a first lens portion centered on an optical axis, and with a second total internal reflection (TIR) lens portion surrounding the first lens portion about the optical axis. The method is further performed by capturing return light from the illuminated target over a field of view of an imaging array, and by projecting the captured return light onto the imaging array.

In accordance with this disclosure, the illuminating light assembly efficiently forms the illumination pattern on and along the target. The optical coupling efficiency between the light source and the hybrid lens component is much improved, thereby increasing illumination light throughput, enhancing reading performance, and improving visibility of the illumination pattern.

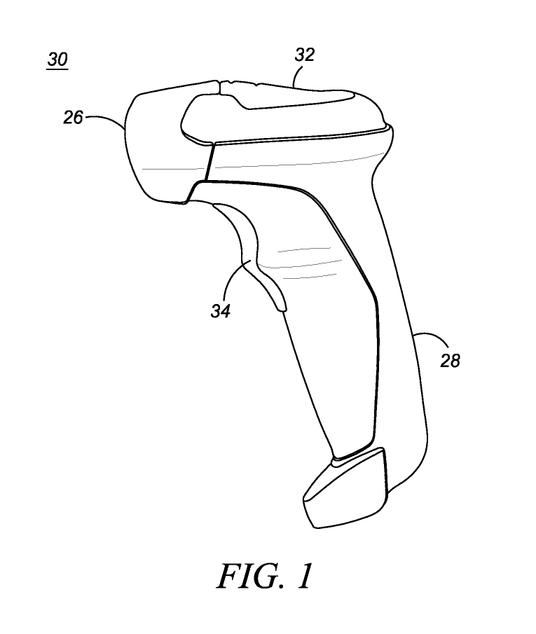

Reference numeral 30 in FIG. 1 generally identifies an ergonomic imaging reader configured as a gun-shaped housing having an upper barrel or body 32 and a lower handle 28 tilted rearwardly away from the body 32 at an angle of inclination, for example, fifteen degrees, relative to the vertical. A window 26 is located adjacent the front or nose of the body 32 and is preferably also tilted at an angle of inclination, for example, fifteen degrees, relative to the vertical. The imaging reader 30 is held in an operator's hand and used in a handheld mode in which a trigger 34 is manually depressed to initiate imaging of targets, especially symbols, to be read in a range of working distances relative to the window 26. Housings of other configurations, as well as readers operated in the hands-free mode, could also be employed.

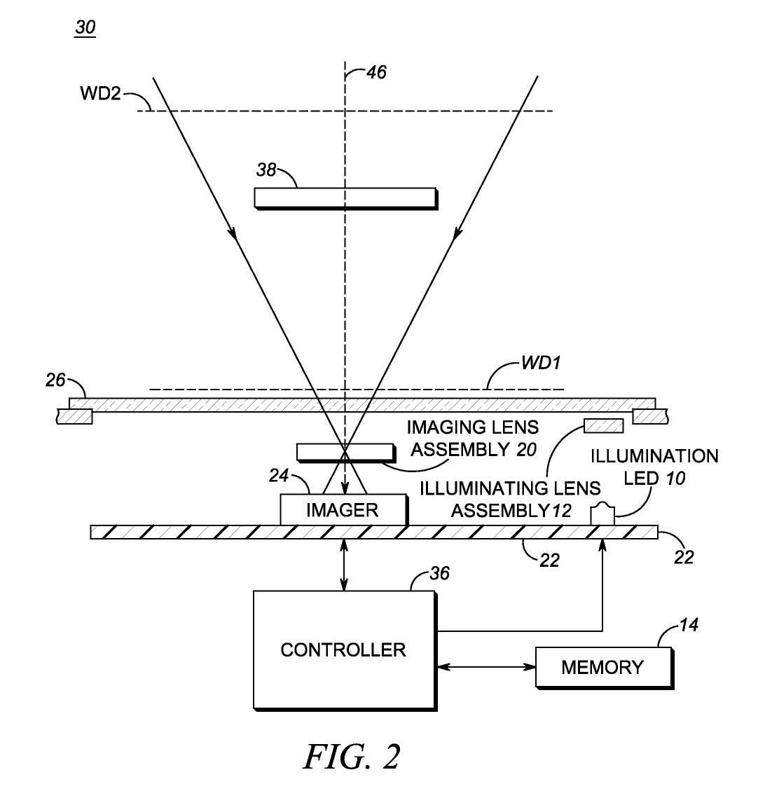

As schematically shown in FIG. 2, an imaging system or module includes an imager 24 mounted on a printed circuit board (PCB) 22 in the reader 30. The PCB 22 is preferably mounted within the tilted handle 28. The imager 24 is a solid-state device, for example, a CCD or a CMOS imager having a one-dimensional array of addressable image sensors or pixels arranged in a single, linear row, or preferably a two-dimensional array of such sensors arranged in mutually orthogonal rows and columns, preferably with an anamorphic field of view, and operative for detecting return light captured by an imaging lens assembly 20 along an imaging axis 46 through the window 26. The return light is scattered and/or reflected from a target or symbol 38 over the field of view. The field of view is generally perpendicular to the imaging axis 46.

The imaging lens assembly 20 is part of the imaging system and is operative for focusing the return light onto the array of image sensors to enable the symbol 38 to be read. The symbol 38 may be located anywhere in a working range of distances between a close-in working distance (WD1) and a far-out working distance (WD2). In a preferred embodiment, WD1 is about one-half inch from the window 26, and WD2 is about thirty inches from the window 26. The imaging lens assembly 20 is located remotely from the window 26, for example, over forty millimeters away.

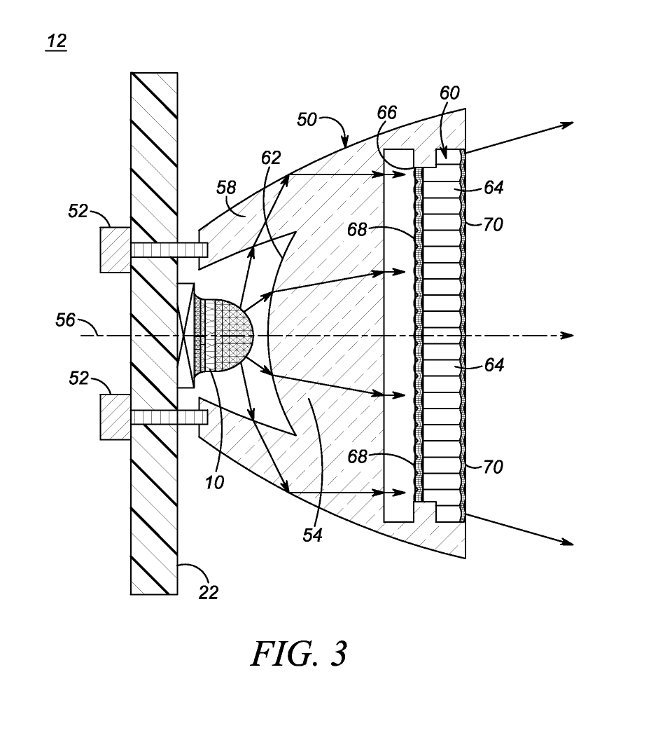

An illuminating light assembly is also mounted in the imaging reader 30 and includes an illumination light source, e.g., a light emitting diode (LED) 10, and an illuminating lens assembly 12 configured to efficiently generate a pattern of illumination light on and along the symbol 38 to be read by image capture. At least part of the scattered and/or reflected return light is derived from the pattern of illumination light on and along the symbol 38. Details of the illuminating light assembly, as best seen in the FIGS. 3-5, are described below.

As shown in FIG. 2, the imager 24 and the LED 10 are operatively connected to a controller or microprocessor 36 operative for controlling the operation of these components. A memory 14 is connected and accessible to the controller 36. Preferably, the microprocessor is the same as the one used for processing the return light from target symbols 38 and for decoding the captured target images.

In operation, the microprocessor 36 sends a command signal to energize the LED 10 for a short exposure time period, say 500 microseconds or less, and energizes and exposes the imager 24 to collect the return light, e.g., illumination light and/or ambient light, from the target symbol 38 only during said exposure time period. A typical array needs about 18-33 milliseconds to acquire the entire target image and operates at a frame rate of about 30-60 frames per second.

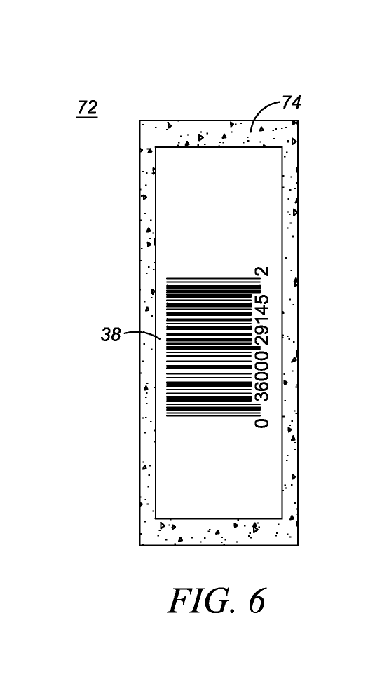

Turning now to FIG. 3, the LED 10 for emitting the illumination light is surface-mounted on the PCB 22, and a hybrid lens component 50 is supported on the PCB 22 in a fixed position in front of the LED 10 with the aid of supports or threaded fasteners 52. The hybrid lens component 50 includes a first lens portion 54 centered on an optical axis 56, and a second total internal reflection (TIR) lens portion 58 surrounding the first lens portion 54 about the optical axis 56. The first lens portion 54 is a positive lens having a convex surface 62 on which the emitted illumination light is incident, and the TIR lens portion 58 is a parabolic reflector element. As is well known, total internal reflection occurs when the emitted illumination light strikes a boundary surface of the lens portion 58 at an angle larger than a particular critical angle with respect to the normal to the boundary surface. Both lens portions 54, 58 are operative for intercepting, bending and collimating the emitted illumination light from the LED 10 with an enhanced optical coupling efficiency to generate an illumination light pattern 72 (see FIG. 6) on the target symbol 38. The TIR lens portion 58 improves the optical coupling efficiency by about 30% as compared to known illuminating light assemblies. The lens portions 54, 58 are commonly molded of a one-piece construction, preferably of a light-transmissive plastic material.

In addition to the hybrid lens component 50, the illuminating light assembly includes a lenslet component 60, which includes an array of cells or lenslets 64 generally arranged in a plane that is generally perpendicular to the optical axis 56. The lenslets 64 are commonly molded of a one-piece construction, preferably of a light-transmissive plastic material. As best seen in FIG. 3, the lenslet component 60 is mounted in a cavity 66 of the hybrid lens component 50, thereby eliminating any separate mounting or alignment mount. As best seen in FIG. 5, the lenslets 64 have individual input aspherical surfaces 68 on which the collimated illumination light is incident, and individual output aspherical surfaces 70 for forming the illumination light pattern 72. The size for each lenslet 64 is typically within 1'1 mm and the center thickness for each lenslet 64 is around 1.5 mm. The surfaces 68, 70 are optical quality grade surfaces with a high aspheric coefficient. The surfaces 68, 70 could be symmetric or non-symmetric about its center optical axis. The optical property of both surfaces 68, 70 and the center thickness determine the field of view (FOV) coming out from that lenslet 64.

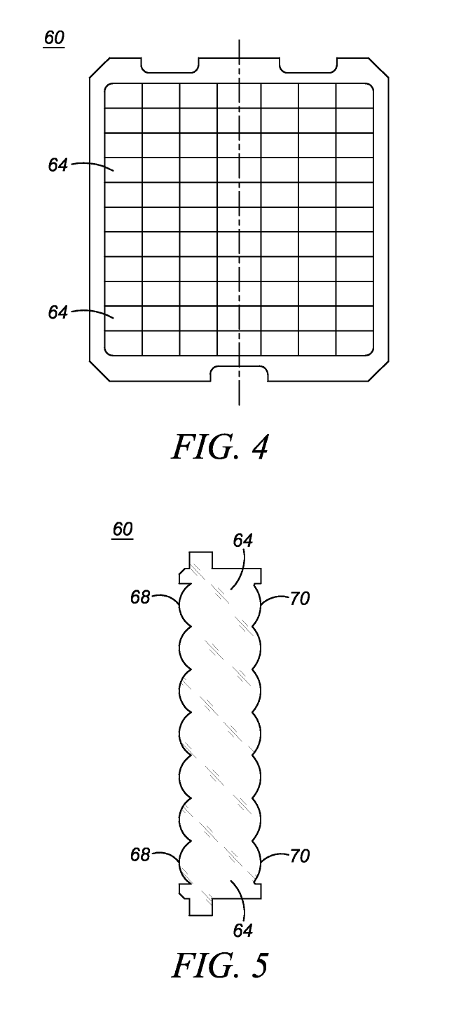

As best seen in FIG. 4, the lenslets 64 are arranged in mutually orthogonal rows and columns, and the lenslets 64 at the ends of the rows and columns have different optical properties than the remaining lenslets 64 to form the illumination light pattern with regions of different light intensity. Thus, as shown in FIG. 5, the illumination light pattern 72 has a generally rectangular border 74 that is illuminated with a dimmer intensity than the interior of the pattern 72, thereby enabling an operator to readily position the symbol 38 within the border of the pattern 72.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An optical illumination system for illuminating a target to be read by image capture, comprising:
an illumination light source component for emitting illumination light; and
a hybrid lens component including a first lens portion centered on an optical axis, and a second total internal reflection (TIR) lens portion surrounding the first lens portion about the optical axis, both lens portions being operative for intercepting, bending and collimating the emitted illumination light to generate an illumination light pattern on the target, and wherein the first lens portion has a convex surface facing the illumination light source.

2. The system of claim 1, wherein the light source component constitutes a light emitting diode (LED).

3. The system of claim 2, and a printed circuit board on which the LED is mounted, and a support for supporting the hybrid lens component in a fixed position relative to the LED on the printed circuit board.

4. The system of claim 1, wherein the first lens portion constitutes a positive lens having a convex surface on which the emitted illumination light is incident, and wherein the TIR lens portion constitutes a parabolic reflector element.

5. The system of claim 1, and a lenslet component including an array of lenslets generally arranged in a plane that is generally perpendicular to the optical axis.

6. The system of claim 5, wherein the hybrid lens component has a cavity in which the lenslet component is mounted.

7. The system of claim 5, wherein the lenslets have individual input aspherical surfaces on which the collimated illumination light is incident, and individual output aspherical surfaces for forming the illumination light pattern.

8. The system of claim 7, wherein the lenslets are arranged in mutually orthogonal rows and columns, and wherein the lenslets at the ends of the rows and columns have different optical properties than the remaining lenslets to form the illumination light pattern with regions of different light intensity.

9. An imaging module for illuminating and imaging an illuminated target to be read by image capture, comprising:
an illuminating light assembly including an illumination light source for emitting illumination light, and a hybrid lens component including a first lens portion centered on an optical axis, and a second total internal reflection (TIR) lens portion surrounding the first lens portion about the optical axis, both lens portions being operative for intercepting, bending and collimating the emitted illumination light to generate an illumination light pattern on the target, and wherein the first lens portion has a convex surface facing the illumination light source; and
an imaging assembly including a solid-state imager having an imaging array of image sensors and an imaging lens assembly for capturing return light over a field of view from the illuminated target, and for projecting the captured return light onto the imaging array.

10. The module of claim 9, and a printed circuit board on which the light source component is mounted, and a support for supporting the hybrid lens component in a fixed position relative to the light source component on the printed circuit board.

11. The module of claim 9, wherein the first lens portion constitutes a positive lens having a convex surface on which the emitted illumination light is incident, and wherein the TIR lens portion constitutes a parabolic reflector element.

12. The module of claim 9, and a lenslet component including an array of lenslets generally arranged in a plane that is generally perpendicular to the optical axis.

13. The module of claim 12, wherein the hybrid lens component has a cavity in which the lenslet component is mounted.

14. The module of claim 12, wherein the lenslets have individual input aspherical surfaces on which the collimated illumination light is incident, and individual output aspherical surfaces for forming the illumination light pattern.

15. The module of claim 14, wherein the lenslets are arranged in mutually orthogonal rows and columns, and wherein the lenslets at the ends of the rows and columns have different optical properties than the remaining lenslets to form the illumination light pattern with regions of different light intensity.

16. A method of illuminating and imaging an illuminated target to be read by image capture, comprising:
emitting illumination light;
intercepting, bending and collimating the emitted illumination light to generate an illumination light pattern on the target by configuring a hybrid lens component with a first lens portion centered on an optical axis, and with a second total internal reflection (TIR) lens portion surrounding the first lens portion about the optical axis, and wherein the first lens portion has a convex surface facing the illumination light source; and
capturing return light from the illuminated target over a field of view of an imaging array, and projecting the captured return light onto the imaging array.

17. The method of claim 16, and configuring the first lens portion as a positive lens having a convex surface on which the emitted illumination light is incident, and configuring the TIR lens portion as a parabolic reflector element.

18. The method of claim 16, and arranging a lenslet component including an array of lenslets in a plane that is generally perpendicular to the optical axis.

19. The method of claim 18, and mounting the hybrid lens component in a cavity of the lenslet component.

20. The method of claim 18, and arranging the lenslets in mutually orthogonal rows and columns, and configuring the lenslets at the ends of the rows and columns with different optical properties than the remaining lenslets to form the illumination light pattern with regions of different light intensity.
